(19) United States
(12) Patent Application Publication
(10) Pub. No.: US 2010/0026037 A1
(43) Pub. Date: Feb. 4, 2010

(54) CANOPY FOR AN OPEN LOAD CARRYING VEHICLE

(76) Inventor: David Victor Opie, Pretoria (ZA)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/722,292

(22) PCT Filed: Dec. 21, 2005
(86) PCT No.: PCT/IB2005/054347

§ 371 Date: Jun. 20, 2007

(30) Foreign Application Priority Data
Dec. 21, 2004 (ZA) 2004/10284

(51) Int. Cl. B60P 7/02

(52) U.S. Cl. 296/100.12; 296/100.18

(57) ABSTRACT

The invention provides a canopy (10) for an open load carrying vehicle (20), such as a pickup truck. The canopy (10) includes an expandable frame comprising a plurality of frame members (52) which are mountable on a load bed (24) of the vehicle (10) such that the frame members (52) are slidably displaceable relative to the load bed (24) to vary the size of the frame. The frame is operable between a retracted condition on the one hand, and, on the other hand, an expanded condition in which the frame extends from a front of the load bed (24) to its rear. A canvas covering (50) is positioned over the frame members (52), and the canopy (10) includes a powered drive means which is drivingly connected to the frame for powered displacement of the frame between its contracted condition and its expanded condition.

THIS INVENTION relates to canopies of open load carrying vehicles. The invention extends to a vehicle which has a convertible canopy.

The invention provides a canopy for an open load carrying vehicle, which canopy includes:

an expandable frame comprising a plurality of frame members which are mountable on a load bed of an open load carrying vehicle such that the frame members are slidably displaceable relative to the load bed to vary the size of the frame, the frame being operable between a retracted condition on the one hand, and, on the other hand, an expanded condition in which the frame extends from a front of the load bed to a rear of the load bed;

a covering which is positioned over the frame members, the covering being of a flexible sheet-like material to permit automatic contraction of the covering during movement of the frame from its expanded condition to its contracted condition; and

a powered drive means which is drivingly connected to the frame for powered displacement of the frame between its contracted condition and its expanded condition.

By open load carrying vehicle is meant a non-articulated vehicle which has a driver's cab and an upwardly open load bed behind the cab.

The frame may comprise a series of arched frame members which, in use, are longitudinally spaced in the fore-and-aft direction of the vehicle, each frame member having an upright orientation and extending transversely across the load bed.

The canopy preferably includes a guiding arrangement which is mountable on the load bed, the frame members being slidingly engaged with the guiding arrangement. The guiding arrangement may comprise two track members which are mountable on opposite side walls of the load bed, in use, so that the track members provide respective tracks which are parallel to each other and extend in the fore-and-aft direction of the vehicle, lower ends of opposite limbs of each frame member being slidably received on the respective tracks to permit sliding of the frame members along the load bed.

Each track member may be configured for mounting on a side wall of a load bed such that a line of contact between the track and the respective frame members are positioned laterally inwardly from the side wall, and the line of contact preferably being lower than the top edge of the side wall.

The drive means may comprise a motor which is drivingly connected to at least one endless drive member extending along an associated track member, the drive member being connected to a rearmost frame member for pulling the rearmost frame member away from or towards a frontmost frame member, to displace the frame into its expanded condition or its contracted condition, as the case may be. In a particular embodiment of the invention, the canvas covering is fast with the rearmost frame member and the central frame members, so that the covering acts as a tensile element for pulling the central frame members train-fashion with the rearmost end member away from the frontmost end member.

Each drive member is typically a drive chain which passes over a driven pulley and a return pulley, the pulleys being mounted at opposite ends of the associated track member. The canopy preferably has a pair of drive chains extending, in use, along opposite side walls of the load bed. The driven pulleys may be located at a front of the frame, being driven by a common drive shaft.

The motor may be arranged to stop movement of the frame when a predetermined maximum resistance to sliding movement of the frame is experienced. Differently defined, the motor may be arranged to exert a predetermined maximum force on the frame during movement of the frame between its expanded condition and its contracted condition. Preferably, the predetermined resistance to movement of the frame, or the predetermined maximum force exerted on the frame, is selected to be sufficiently small to prevent serious injury to a person whose hand is caught between contracting frame members.

Advantageously, the frontmost frame member and the rearmost frame member together form a casing when the frame is in its contracted condition, the remaining, central frame members and the covering being housed in a hollow interior of the casing. It will be appreciated that at least the frontmost frame member, and preferably the rearmost frame member too, are somewhat larger than the central frame members. With central frame members are meant all the frame members with the exception of the frontmost and rearmost frame members.

The frontmost frame member and the rearmost frame member may have respective outer shells of a rigid plate material, preferably steel plate, so that when the canopy is in its contracted condition, the casing presents a rigid composite outer shell. The outer shell of the frontmost frame member and the outer shell of the rearmost frame member are preferably positioned end to end and form a flush junction, when the canopy is in its contracted condition, the frontmost frame member and the rearmost frame member having identical end profiles. The frontmost frame member is preferably mountable on an open load carrying vehicle such that it abuts a driver's cab of the vehicle, the frontmost frame member being stationary relative to the load bed, in use, so that central frame members between the frontmost and the rearmost frame member are displaceable relative to the frontmost frame member.

The frontmost frame member preferably defines a frame cavity for reception of the central frame members and the covering, the frame cavity being complementary in shape to the profile of the central frame members and being bordered by a radially outer wall and a radially inner wall, so that the frame cavity is part-annular in shape, being inverted U-shaped in profile when seen from a rear end of the vehicle, and extends peripherally around upper and side portions of a storage cavity defined on a radially inner side of the inner wall of the frontmost frame member.

The storage cavity may be bordered on its lower side by a displaceable floor member which is displaceable between a closed position in which it closes off the storage cavity, and an open position in which the storage cavity is downwardly open. It will be appreciated that, when the canopy is in its contracted condition and the floor member is in its closed position, the storage cavity is completely closed off, being bordered on its bottom by the floor member, on its front by the cab, on its rear by the rearmost frame member, and on its sides and on top by the frontmost frame member. In a preferred embodiment, the storage cavity is accessible through the rear of the driver's cab by virtue of an openable window which connects the storage cavity and the driver's cab, in use.

The floor member may be mounted on the frontmost frame member, being lockably engageable with the rearmost frame member, or vice versa, when the canopy is in its contracted condition, so that the floor member serves as a retaining member for retaining the canopy in its contracted condition and preventing expansion of the frame by sliding movement of the rearmost frame member relative to the frontmost frame member.

The floor member is optionally hingedly mounted on the frontmost frame member for pivoting about an operatively horizontal axis, the floor member being horizontally oriented when it is engaged with the rearmost frame member, so that the floor member is arranged for automatically assuming a vertical orientation in response to disengagement from the rearmost frame member by movement of the rearmost frame member away from the frontmost frame member. The floor member may be connected to a base plate which is co-planar with the floor plate when the floor plate is closed, so that the base plate provides a shelf at the front of the load bed when the frame is in its expanded condition.

The rearmost frame member may include a rear door which is hingedly mounted for displacement between an open position and a closed position. Preferably, the rear door is displaceable about an operatively horizontal hinge axis located at an upper end of the rearmost frame member. The rear door may have a window which is optionally aligned, in use, with a window in the rear of the driver's cab.

The canopy may include a warning arrangement for producing an audible warning signal in response to movement of the frame members relative to the load bed.

The canopy optionally includes a remote control arrangement for permitting remote control of movement of the frame between its expanded condition and its contracted condition. The remote control arrangement may include a remote control device for producing a wireless command signal to which the drive is receptive. Instead, or in addition, the remote control arrangement may include a control switch which is mountable in the cab of a vehicle on which the frame is, in use, fitted.

The invention extends to a vehicle which includes:

a load bed positioned behind a driver's cab; and

a canopy as described above, the canopy being mounted on the load bed, so that when the canopy is in its contracted condition the majority of the load bed is upwardly open, while the load bed is covered by the canopy when the canopy is in its expanded condition.

The invention will now be described by way of example with reference to the accompanying diagrammatic drawings, in which:

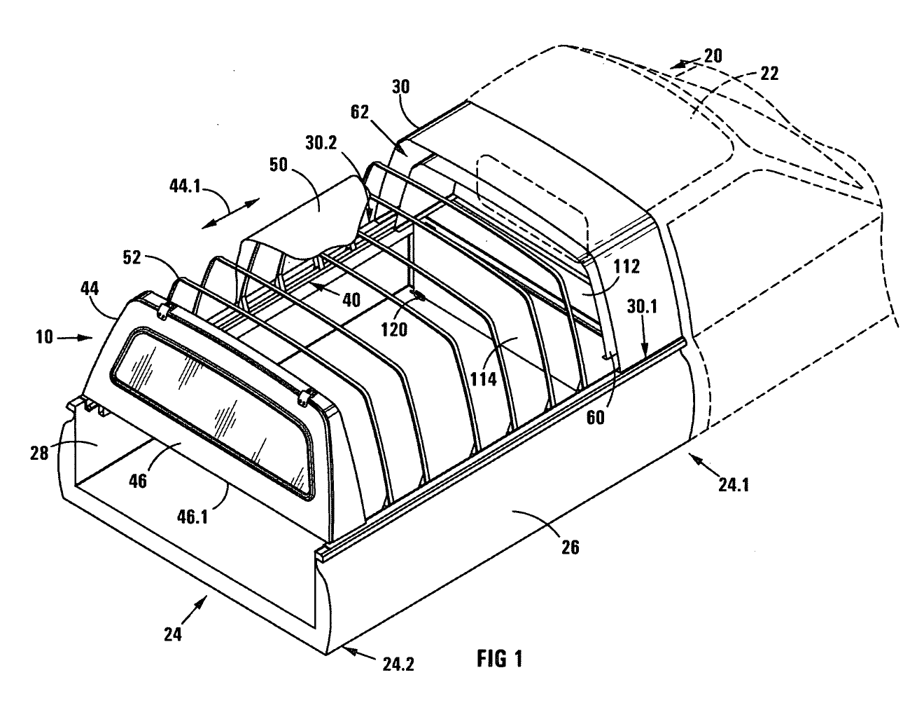

FIG. 1 is a three-dimensional view of a canopy for an open load vehicle in accordance with the invention, the canopy being shown mounted on the load bed of a utility vehicle;

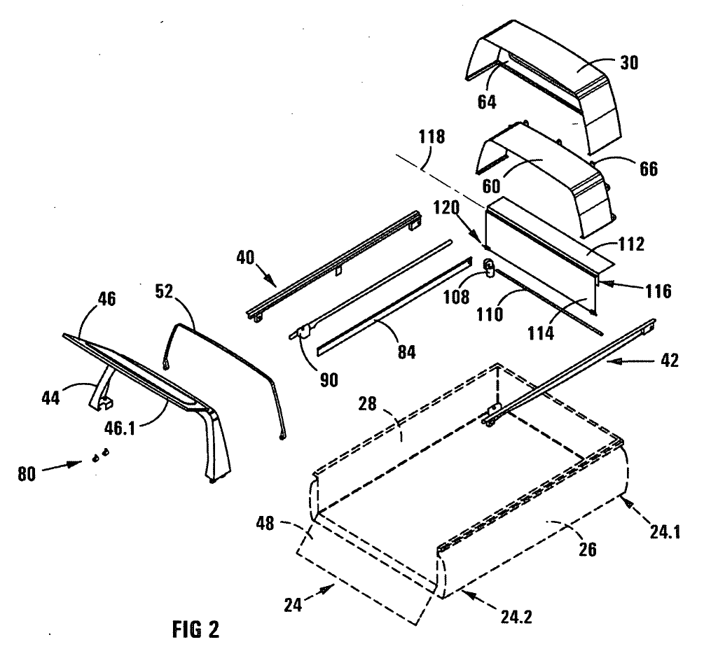

FIG. 2 is an exploded three-dimensional view of the canopy of FIG. 1;

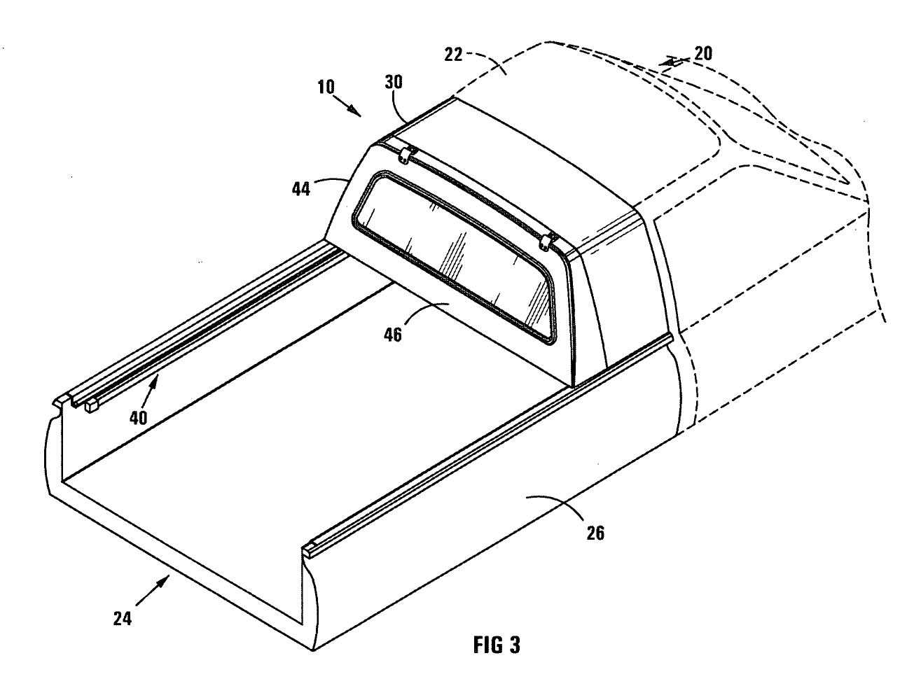

FIG. 3 is a three-dimensional view similar to FIG. 1, the canopy being in a contracted condition so that the load bed is exposed;

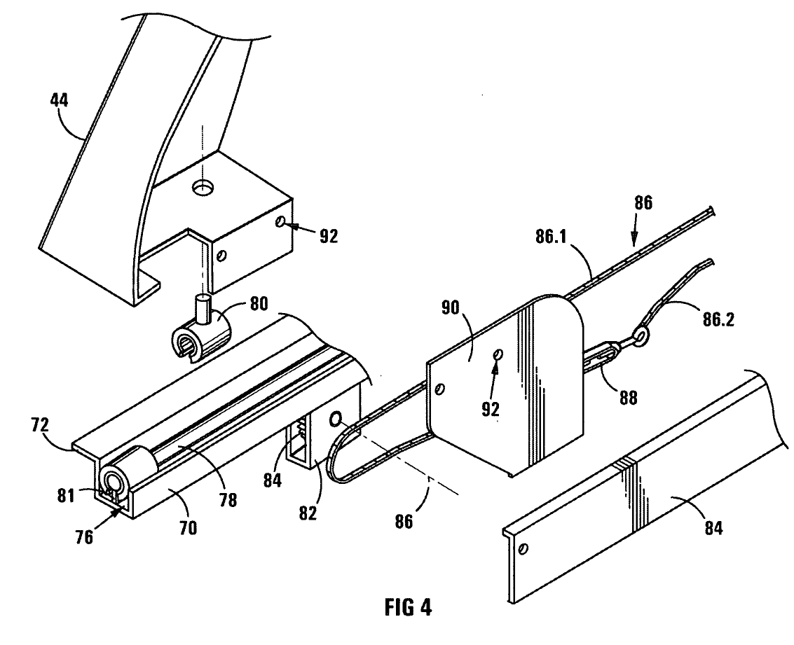

FIG. 4 is, on an enlarged scale, a three-dimensional view of the rear end of a guiding arrangement forming part of the canopy of FIG. 1; and

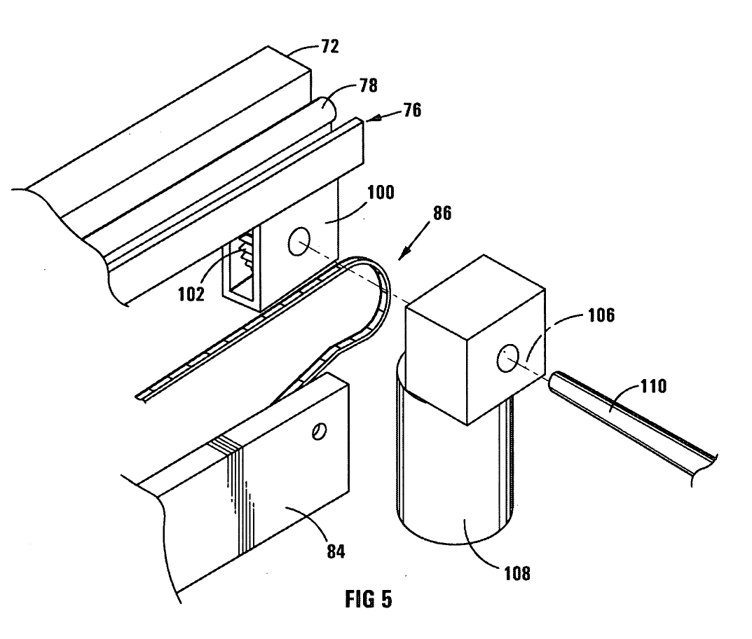

FIG. 5 is a view corresponding to FIG. 4 of the front end of the guiding arrangement which forms part of the canopy.

Referring to the drawings, reference numeral 20 refers generally to a utility vehicle in the form of a pickup truck or vehicle, the vehicle 20 having a cab 22 and a load bed generally indicated by reference numeral 24. The load bed 24 has a front end 24.1 and a rear end 24.2. The width of the load bed, is defined by laterally spaced, parallel, upright side walls 26 and 28.

Reference numeral 10 generally indicates a canopy in accordance with the invention. The canopy 10 includes a front frame member or housing 30 having mounting means for mounting it on the load bed 24 to straddle the front end 24.1 of the load bed 24, so that lower ends 30.1 and 30.2 of the housing 30 rest on side walls 26 and 28 of the load bed 24 adjacent its front end 24.1.

The canopy 10 further includes a guiding arrangement which comprises a pair of elongate track members 40 and 42, having securing means for securing them in transversely spaced parallel relationship along the upper edges of the side walls 26 and 28 of the vehicle 20. Each track member 40, 42 provides a rectilinear track 78 which extends along the fore-and-aft direction of the vehicle 20. As is best seen from FIG. 2 of the drawings, the length of the tracks 78 matches the length of the load bed 24.

The canopy 10 further includes a rearmost frame member or end member 44 which straddles the laterally spaced track members 40 and 42. The end member 44 is slidably displaceable along the pair of track members 40 and 42, in the direction of double-headed arrow 44.1.

A flap or door 46 is hingedly connected to the end member 44. A lower edge 46.1 of the flap 46, in use, lines up with the upper edge of the tail gate 48 (see FIG. 2) of the vehicle 20, when the tailgate 48 is in a vertical, closed position.

A covering 50 of flexible sheet material, in this case canvas, is provided to define a roof of the canopy 10. In order to provide support to the covering 50 (only part of which is shown in FIG. 1) the canopy has a plurality of central frame members or stays 52 spaced longitudinally in series, the covering 50 connected to the respective stays 50 at regular intervals corresponding to the total length of the load bed divided by then number of stays. The stays 52, the housing 50 and the end member 44 thus together define an articulated or expandable frame. The housing 50, end member 44, and stays 52 each has an arch shape or an inverted U-shape roughly matching the profile of the cab 22, when seen in end view. The stays 52 are identical to each other but are somewhat smaller than the housing 30 and the end member 44, so that they can be received in a composite casing formed by the housing 30 and the end member 44, when the canopy 10 is in a contracted condition (FIG. 3).

The housing 30 includes a radially inner wall 60 spaced inwardly from its outer periphery or outer wall, defining a part-annular frame cavity 62 within which the stays 52 and covering 50 are receivable when the end member 44 is in its retracted position, as shown in FIG. 3 of the drawings. The inner wall 60 is secured to a front wall 64 of the housing 30, by lugs 66 which are secured by screws to the front wall 64.

Referring now to FIG. 4, details of construction of the rear end of the left track member 40 are shown. The track member 40 includes an elongate rail member 70 having an elevated flange formation 72 raised above a channel portion 76. The rail member 70 is secured to the side wall 26 of the vehicle 20 by means of longitudinally spaced screws or bolts (not shown), the rail member 70 lying flat on a top edge of the side wall 26. Inside the channel formation 76 is mounted the track in the form of an elongate rod of circular section which forms a rail head. The rail head slidably receives shoes 80 which are connected to the lower ends of the associated limbs of each of the stays 52 and of the end member 44. The stays 52 and end member 44 are thus slidably displaceable along the track members 40 by sliding of the shoes 80 along the rail head. It will be appreciated that the line of contact between the track members 40 and the frame members 44, 52 are spaced inwardly from the side walls 26, 28 and are positioned lower than the top edges of the side walls 26, 28. This permits the laterally outer surfaces of the housing 30 and the end member 44 to be longitudinally aligned and to be more or less vertically aligned with the outer surfaces of the side walls 26, 28.

The rail head 78 is supported longitudinally by pedestals 82 spaced along the length of the channel member 76.

In another embodiment of the invention, the linear track members 40, 42 can be provided by employing a C-track cooperating with roller bearings provided on the end member 44 and the stays 52.

Referring further to FIG. 4 of the drawings, reference numeral 82 indicates a box shaped structure secured to the under side of the channel formation 76 inwardly from its rear end. The structure 82 serves to support a return pulley or tail sprocket 84 for rotation about an axis 86. The sprocket 82 provides support to an endless drive chain, generally indicated by reference numeral 86. The chain 86 has an upper run 86.1 and a lower run 86.2.

The lower run 86.2 of the chain 86 has a turn buckle 88 for adjusting the tension in the chain 86. The end member 44 is secured to the chain 86 by a mounting plate 90 which is connected to the lower run 86.2 of the chain 86, the end member 44 being secured to the plate 90 by bolts passing through connection holes 94. A cover plate 64 is connected to the laterally inner side of the track member 40, covering the drive chain 86 and isolating it from a load space above the load bed 24.

FIG. 5 of the drawings shows details of front ends of the left track member 40. It will be understood that the left track member 40 is a mirror image of the right track member 42.

At the front end of the track member 40, a box shaped member 100 is secured to the under side of the channel formation 76. The member 100 serves to provide rotational support to a driven pulley or head sprocket 102 of the drive chain 86. The sprocket 102 is rotatably supported by the box shaped member 100 for rotation about axis 106, which is parallel to the axis 86 of the tail sprocket 84. Rotation of the head sprocket 102 about its axis 106 causes displacement of the end member 44, in the direction of arrow 44.1.

A powered drive in the form of an electric motor 108 is drivingly connected to the sprockets 102. In this embodiment the two head sprockets 102 for the left and right sides are mounted on a common shaft 110. This shaft 110 is concealed under a shelve-like platform or base plate 112 provided at the front end of the load bed 24 (see FIG. 2). The base plate forms part of the housing 30.

Typically, a gearing arrangement (not shown) e.g. a bevel-and-pinion gear arrangement is provided to drive the shaft 110.

A hinged flap or floor plate 114 is hung from the rear edge 116 of the base plate 114, to hinge about an axis 118. A locking arrangement in the form of sliding bolts 120 are provided for securing the hinge flap 114 in a locked position by engaging with co-operating openings (not shown) defined by the end member 44. When the floor plate 114 is thus in a closed position in which it is oriented horizontally and its sliding bolts 120 are received by the end member 44, the floor plate serves as a restraining member for restraining sliding movement of the end member 44 away from the housing 30, thus keeping the canopy in its contracted condition.

It will further be seen that the floor plate 114, when in its closed position, closes off a storage cavity defined by the flap 114, the base plate 112 and the rear member 44, the inner wall 60 of the housing 30 and the front wall 64 of the housing 30.

Although not shown in the drawings, operation of the motor 108 is controllable by a remote control arrangement which includes a remote control device for emitting a wireless command signal which communicates, in use, with a receiver mounted on the vehicle 20 and in communication with the motor 108. In an alternative embodiment, the control arrangement can include a control switch located in the driver's cab 22.

The motor or the control arrangement is further arranged to cease movement the transmission of torque by the motor 108 to the drive shaft 110 when resistance to movement of the end member 44 is greater than a pre-determined or pre-set value. In the present embodiment, the predetermined minimum resistance to movement of the end member 44 which is required to halt movement of the end member 44 under urging of the motor 108 is roughly equal to the force exerted on the end member 44 by an adult pushing with mild exertion against the end member 44. This limit on the force which can be exerted by the motor 108 on the end member 44 via the chain 86 is a safety mechanism for preventing injury to persons which might be snagged by the canopy 10 during movement from or to its contracted condition.

As an additional safety measure, the canopy 10 includes a warning arrangement in the form of a speaker (not shown) for producing an audible alarm whenever the end member 44 is moving.

In use, the vehicle 20 is convertible between having a covered load bed 24 and having an open load bed.

When the canopy 10 is in its contracted condition (FIG. 3), the housing 30 and the end member 44 are positioned end to end and are connected together by the floor plate 114 which is locked to the end member 44. The outer surfaces of the end member 44 and the housing (which can be of plate metal or any other rigid plate-like material, such as fibre reinforce resin) are flush and in abutment, together forming a neat and compact casing in which the stays 52 and the covering 50 are held. As described above, the stays 52 and the covering 50 are located in the frame cavity defined between the inner wall 60 and the outer wall of the housing 30.

The composite casing furthermore defines a storage space which is neatly separated from the stays 52 and covering 50 by the inner wall 60 of the housing 30. The storage space can be accessed by opening the rear door 46 mounted on the end member 44, even when the canopy 10 is in its contracted condition. Objects can be stored on the base plate 112 and the floor plate 114, which together form a floor of the storage cavity. The storage cavity can further be accessed through a window in the rear or the driver's cab 22.

When a driver of the vehicle 20 however wishes the load be 24 to be covered, the motor 108 is activated, optionally by use of the remote control device. The motor 108 applies torque to the drive shaft 110 and thus turns the head sprockets 102, thus transferring drive to the chains 86. Driving movement of the chains 86 results in rearward sliding movement of the end member 44 away from the housing 30. When rearward movement of the end member 44 starts, the floor plate 114 automatically disengages the end member 114 and falls downwardly to an open position.

The end member 44 pulls the stays 52 rearward, train-fashion, because of the connection of the stays 52 to the covering 50. The covering 50 serves the additional purpose of being a tensile element for pulling the stays 52 rearward along with the driven end member 44. The end member 44 is displaced fully rearwards until it reaches the ends of the track members 40, 42, in which position the rear door 16 of the end member 44 is aligned with the tail gate 48 of the vehicle 20.

In this expanded condition, the canopy 10 covers the load bed 24 of the vehicle in conventional fashion. Even in the expanded condition, the base plate 112 provides a convenient storage shelf adjacent the cab 22. The covering 50 includes ventilation openings in its sides and optionally in its top, for promoting ventilation in the load space. A reflector (not shown) is provided on the rear door 16.

When the canopy 10 is again to be retracted, the motor 108 is rotated in the opposite direction, pulling the end member 44 forward by the chain 86. The end member sequentially collects the respective stays 52, which are shunted along the track members 40, 42 back into the frame cavity provided by the housing. During such contraction of the articulated frame, the canvas covering folds up concertina-fashion for compact reception in the housing 30.

1. A canopy for an open load carrying vehicle, which canopy includes:
an expandable frame comprising a plurality of frame members which are mountable on a load bed of an open load carrying vehicle such that the frame members are slidably displaceable relative to the load bed to vary the size of the frame, the frame being operable between a retracted condition on the one hand, and, on the other hand, an expanded condition in which the frame extends from a front of the load bed to a rear of the load bed;
a covering which is positioned over the frame members, the covering being of a flexible sheet-like material to permit automatic contraction of the covering during movement of the frame from its expanded condition to its contracted condition; and
a powered drive means which is drivingly connected to the frame for powered displacement of the frame between its contracted condition and its expanded condition.

2. A canopy as claimed in claim 1, in which the frame comprises a series of arched frame members which, in use, are longitudinally spaced in the fore-and-aft direction of the vehicle, each frame member having an upright orientation and extending transversely across the load bed.

3. A canopy as claimed in claim 2, which includes a guiding arrangement which is mountable on the load bed, the frame members being slidingly engaged with the guiding arrangement.

4. A canopy as claimed in claim 3, in which the guiding arrangement comprises two track members which are mountable on opposite side walls of the load bed, in use, so that the track members provide respective tracks which are parallel to each other and extend in the fore-and-aft direction of the vehicle, lower ends of opposite limbs of each frame member being slidably received on the respective tracks to permit sliding of the frame members along the load bed.

5. A canopy as claimed in 4, in which each track member is configured for mounting on a side wall of a load bed such that a line of contact between the track and the respective frame members are positioned laterally inwardly from the side wall.

6. A canopy as claimed in claim 4 or claim 5, in which the drive means comprises a motor which is drivingly connected to at least one endless drive member extending along an associated track member, the drive member being connected to a rearmost frame member for pulling the rearmost frame member away from or towards a frontmost frame member, to displace the frame into its expanded condition or its contracted condition, as the case may be.

7. A canopy as claimed in claim 6, in which each drive member is a drive chain which passes over a driven pulley and a return pulley, the pulleys being mounted at opposite ends of the associated track member.

8. A canopy as claimed in claim 7, which includes a pair of drive chains extending, in use, along opposite side walls of the load bed.

9. A canopy as claimed in claim 8, in which the driven pulleys are located at a front of the frame and are driven by a common drive shaft.

10. A canopy as claimed in any one of claims 6 to 9 inclusive, in which the motor is arranged to stop movement of the frame when a predetermined maximum resistance to sliding movement of the frame is experienced.

11. A canopy as claimed in any one of claims 2 to 10 inclusive, in which the frontmost frame member and the rearmost frame member together form a casing when the frame is in its contracted condition, the remaining, central frame members and the covering being housed in a hollow interior of the casing.

12. A canopy as claimed in claim 11, in which the frontmost frame member and the rearmost frame member have respective outer shells of a rigid plate material, so that when the canopy is in its contracted condition, the casing presents a rigid composite outer shell.

13. A canopy as claimed in claim 12, in which the outer shell of the frontmost frame member and the outer shell of the rearmost frame member are positioned end to end and form a flush junction, when the canopy is in its contracted condition.

14. A canopy as claimed in any one of claims 11 to 13 inclusive, in which the frontmost frame member is mountable on an open load carrying vehicle such that it abuts a driver's cab of the vehicle, the frontmost frame member being stationary relative to the load bed, in use, so that central frame members between the front most and the rearmost frame member are displaceable relative to the front most frame member.

15. A canopy as claimed in claim 14, in which the frontmost frame member defines a frame cavity for reception of the central frame members and the covering, the frame cavity being complementary in shape to the profile of the central frame members and being bordered by a radially outer wall and a radially inner wall, so that the frame cavity is part-annular in shape and extends peripherally around upper and side portions of a storage cavity defined on a radially inner side of the inner wall of the frontmost frame member.

16. A canopy as claimed in claim 15, in which the storage cavity is bordered on its lower side by a displaceable floor member which is displaceable between a closed position in which it closes off the storage cavity, and an open position in which the storage cavity is downwardly open.

17. A canopy as claimed in claim 16, in which the floor member is mounted on the frontmost frame member and is lockably engageable with the rearmost frame member, or vice versa, when the canopy is in its contracted condition, so that the floor member serves as a retaining member for retaining the canopy in its contracted condition and preventing expansion of the frame by sliding movement of the rearmost frame member relative to the frontmost frame member.

18. A canopy as claimed in claim 17, in which the floor member is hingedly mounted on the frontmost frame member for pivoting about an operatively horizontal axis, the floor member being horizontally oriented when it is engaged with the rearmost frame member, so that the floor member is arranged for automatically assuming a vertical orientation in response to disengagement from the rearmost frame member by movement of the rearmost frame member away from the frontmost frame member.

19. A canopy as claimed in any one of claims 2 to 18 inclusive, in which the rearmost frame member includes a rear door which is hingedly mounted for displacement between an open position and a closed position.

20. A canopy as claimed in any one of the preceding claims, which includes a warning arrangement for producing an audible warning signal in response to movement of the frame members relative to the load bed.

21. A canopy as claimed in any one of the preceding claims, in which the canopy includes a remote control arrangement for permitting remote control of movement of the frame between its expanded condition and its contracted condition.

22. A canopy as claimed in claim 21, in which the remote control arrangement includes a remote control device for producing a wireless command signal to which the drive is receptive.

23. A canopy as claimed in claim 22, in which the remote control arrangement includes a control switch which is mountable in the cab of a vehicle on which the frame is, in use, fitted.

24. A vehicle which includes:
a load bed positioned behind a driver's cab; and
a canopy as claimed in any one of claims 1 to 23 inclusive, the canopy being mounted on the load bed, so that when the canopy is in its contracted condition the majority of the load bed is upwardly open, while the load bed is covered by the canopy when the canopy is in its expanded condition.

25. A canopy as claimed in claim 1, substantially as herein described and illustrated.

26. A vehicle as claimed in claim 24, substantially as herein described and illustrated.
